(19) United States
(12) Patent Application Publication
(10) Pub. No.: US 2023/0274295 A1
(43) Pub. Date: Aug. 31, 2023

(54) HALFALOGUE INSIGHT GENERATION

(71) Applicant: Accenture Global Solutions Limited, Dublin (IE)

(72) Inventors: Shannon Copeland, Atlanta, GA (US); Burton M. Smith, III, Panama City Beach, FL (US)

(21) Appl. No.: 18/111,046

(22) Filed: Feb. 17, 2023

Related U.S. Application Data
(60) Provisional application No. 63/314,025, filed on Feb. 25, 2022.

(51) Int. Cl. G06Q 30/0201; G06Q 30/02

(52) U.S. Cl. CPC G06Q 30/0201; G06Q 30/0281

(57) ABSTRACT

Halfalogue insight generation is presented. Example embodiments include receiving speech from a sales call between at least two participants including an agent and a customer; identifying from the conversation speech contributions of a subset of the participants; converting the speech contributions to text; parsing the converted text into halfalogue triples; storing the halfalogue triples in an enterprise knowledge graph of a semantic graph database; generating real-time sales insights in dependence upon the speech contributions of the sales call and the stored halfalogue sales triples in the enterprise knowledge graph; and presenting the real-time sales insights to one or more sales agent.

### PRIORITY CLAIM

This application claims priority to U.S. Provisional Application No. 63/314,025 filed on Feb. 25, 2022, the entire content of which is incorporated herein by reference.

### BACKGROUND

In some jurisdictions, recording a participant of a call may be forbidden by local law or may require the explicit permission of the recorded participant or all participants. In other jurisdictions, any participant may consent to a recording. Even in cases where a participant does not consent to recording or when gaining such consent may be off-putting or unpleasant, recording the other participants of a call may be useful.

### SUMMARY

In general, one innovative aspect of the subject matter described in this specification can be embodied in methods for halfalogue insight generation that include the actions of receiving speech from a sales call between at least two participants including an agent and a customer. The methods include identifying from the conversation, speech contributions from a subset of the participants, converting the speech contributions to text, parsing the converted text into halfalogue triples, storing the halfalogue triples in an enterprise knowledge graph of a semantic graph database, generating real-time sales insights from the stored halfalogue triples in the enterprise knowledge graph, and presenting the real-time sales insights to one or more sales agent.

Other embodiments of this aspect include corresponding computer systems, apparatus, computer products, and computer programs recorded on one or more computer storage devices, each configured to perform the actions of the methods.

The foregoing and other embodiments can each optionally include one or more of the following features, alone or in combination. In particular, one embodiment includes all the following features in combination. In some implementations, identifying the speech contributions includes comparing a voice print of at least one participant within the speech contributions.

In some implementations, identifying the speech contributions includes identifying speech contributions from all participants of the sales call and recording speech contribution of only the subset of the participants.

In some implementations, identifying the speech contributions includes identifying speech contribution of the sales agent and recording the speech contribution of the sales agent.

In some implementations, converting the speech contributions to text includes invoking an automated speech recognition engine to convert the speech contributions into text using a grammar module, a lexicon module, and an acoustic model.

In some implementations, parsing the converted text into halfalogue triples includes applying a halfalogue taxonomy.

In some implementations, generating real-time sales insights based on the stored halfalogue triples in the enterprise knowledge graph includes querying an enterprise knowledge graph storing the halfalogue triples and identifying one or more insights in dependence upon query results.

In some implementations, the real-time sales insights include budget, authority, need, and time insights.

In some implementations, the methods further include determining, from the halfalogue triples, an industry for the speech contributions, where the real-time sales insights are selected based in part on the industry.

In one or more implementations, the technology described herein can provide one or more of the following advantages. By providing a collection of artificial intelligence-based technologies, including natural and semantic language processing, the technology described herein allows for generating real-time insights based only on speech contributions of a subset of participants in a conversation associated with a sales call. For example, at times, only the speech contributions of a sales-agent is recorded and can be used to generate insights into the sales call. The generation of such relevant recommendations in real time can in turn can potentially improve quality, efficiency, and efficacy of outside sales calls, even in situations where one or more parties to a call do not consent to being recorded. Contextual awareness can be used to dynamically adapt and improve processing of the speech contributions and generation of insights. Moreover, processing of speech contributions can be adapted based on the identities or role of the contributors, where variables related to sampling of speech contributions can be adjusted based in part on the identity and/or role of the contributor of the speech contribution. For example, the system can build taxonomies including vocabulary specific to halfalogue speech contributions attributed to sales-agents, where the taxonomies can be biased around the sales-agent script and training, leading to more efficient and accurate generation of insights from the speech contributions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 sets forth a network diagram illustrating an example system for halfalogue insight generation according to embodiments of the present technology.

FIG. 2 sets forth a line drawing of an example system for halfalogue insight generation according to embodiments of the present technology.

FIG. 3 sets forth a line drawing of an example system for halfalogue insight generation according to embodiments of the present technology

FIG. 4 sets forth a system diagram of a system for halfalogue insight generation according to embodiments of the present technology.

FIG. 5 sets forth a line drawing of a graph.

FIG. 6 sets forth a block diagram of automated computing machinery comprising an example of a computer useful as a voice server for halfalogue insight generation according to embodiments of the present technology.

FIG. 7 sets forth a block diagram of automated computing machinery comprising an example of a computer useful as a triple server for halfalogue insight generation according to embodiments of the present technology.

FIG. 8 sets forth a flow chart illustrating an example method of halfalogue insight generation according to embodiments of the present technology.

### DETAILED DESCRIPTION

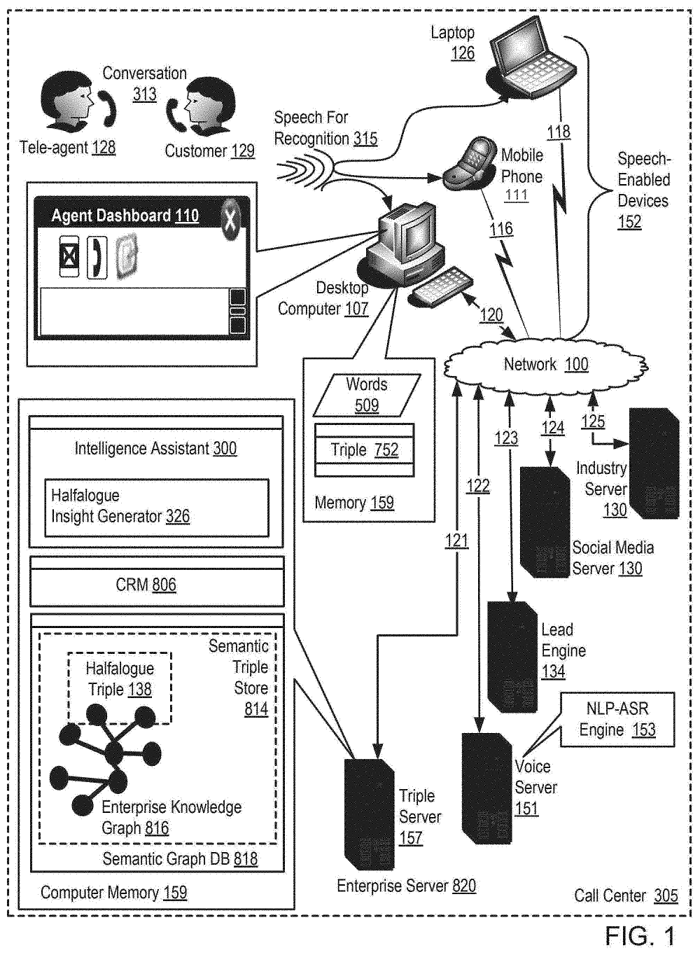

Example methods, systems, apparatuses, and products for halfalogue insight generation are described with reference to the accompanying drawings, beginning with FIG. 1. FIG. 1 sets forth a network diagram illustrating an example system for halfalogue insight generation according to embodiments of the present technology. ‘Halfalogue’ as used in this specification can be taken to mean the speech contributions of fewer than all participants in a conversation. For example, a halfalogue can refer to the speech contributions of an agent who is in conversation with customer(s), e.g., where at least one of the customer(s) has not authorized recording/processing of respective customer speech contributions. By contrast, a dialog as used herein is the complete speech participation of all participants in a conversation. The term halfalogue is not meant to mean or imply that half or more than half of the participants contribute speech, only that less than all of the participants' speech is considered part of the halfalogue.

FIG. 1 sets forth a network diagram illustrating an example system for halfalogue insight generation according to embodiments of the present technology and is implemented with at least one speech-enabled device (152), a triple server (157), and a voice server (151). A speech-enabled device is automated computing machinery configured to accept and recognize speech from a user and often express to a user voice prompts and speech responses. Speech-enabled devices in the example of FIG. 1 include a desktop computer (107), a mobile phone (111), a laptop computer (126), and an enterprise server (820) supporting an intelligence assistant (300) according to embodiments of the present technology. Each speech-enabled device in this example is coupled for data communications through a network (100) to the triple server (157) and the voice server (151). Although described here as a triple server (157) and voice server (151), the operations described with reference to each of the triple server (157) and voice server (151) can be performed by more or fewer servers in data communication with each other and with enterprise server 820 and one or more computer devices through network 100. In some implementations, enterprise server 820 can perform the operations described here with reference to the triple server (157) and/or voice server (151).

The overall example system illustrated in FIG. 1 operates generally for halfalogue insight generation by receiving speech from a sales call between at least two participants including at least one agent and at least one customer. The speech may be received on a speech enabled device such as a desktop computer operating an agent dashboard (110), a mobile phone (111), a laptop (126), a telephone with an associated private branch exchange (PBX), virtual PBX, a voice over internet protocol (VOIP) phone, or any other speech enabled device.

The example system of FIG. 1 also operates generally by identifying a subset of the participants from the conversation speech collected for recognition. In the example of FIG. 1, only two participants are depicted, a tele-agent (128) and a customer (129). In this example, a subset of these participants would be either the tele-agent or the customer. The depiction of only two participants of the conversation is for ease of explanation. In fact, sales calls according to embodiments of the present technology often have many participants and any number of such participants may contribute to halfalogue insight generation according to embodiments of the present technology.

The example system of FIG. 1 also operates generally by converting the speech for recognition to text. In other words, the term “speech for recognition” refers to recorded and/or real-time speech contributions from one or more participants that is converted to text, e.g., using speech-to-text methods, and used to generate the insight(s) as described in further detail below. In the example of FIG. 1, speech for recognition is converted to text by invoking a natural language processing and automatic speech recognition (NLP-ASR) engine (153) operating on a voice server (151) is described in more detail below.

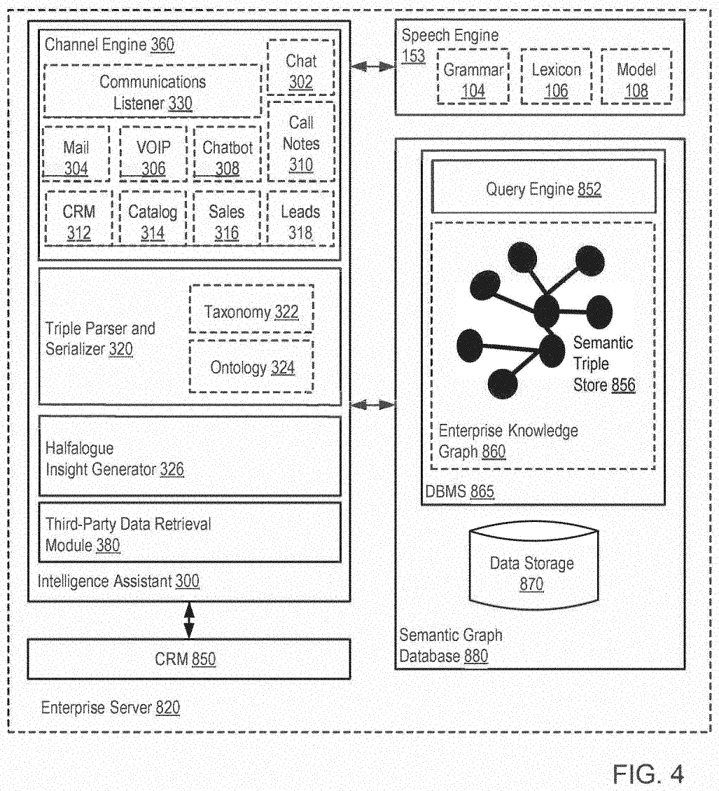

The example system of FIG. 1 also operates generally by parsing the converted text of the speech contributions from the one or more participants of a call into halfalogue triples (138) and storing the halfalogue triples (138) in an enterprise knowledge graph (816) of a semantic graph database (818). In the example of FIG. 1, an intelligence assistant (300) residing on an enterprise server (820) parses the converted text into halfalogue triples (138) using a triple parser/serializer and stores the triples (138) in a semantic triple store (814) of enterprise knowledge graph (816) of a semantic graph database (818). Further details related to the triple parser and serializer are discussed with reference to FIG. 4 below.

The example system of FIG. 1 also operates generally by generating real-time sales insights based in part upon the speech for recognition (315) of the sales call and the stored halfalogue triples in the enterprise knowledge graph (816) and presenting the real-time sales insights to one or more sales agents (128). In the example of FIG. 1, a halfalogue insight generator (326) of an intelligence assistant generates sales insights from results of real-time queries of the enterprise knowledge graph.

As mentioned above, halfalogue insight generation according to various embodiments of the present technology is speech-enabled. In some implementations, a word (509) of digitized speech is speech for recognition from a tele-agent (128) or a conversation between the tele-agent (128) and a customer. The speech for recognition can be an entire conversation, where, for example, all persons speaking are in the same room, and the entire conversation is picked up by a microphone on a speech-enabled device.

In some implementations, a scope of speech for recognition can be reduced by providing, to a speech-enabled device conversation, speech from only one person or a person on one side of a conversation, e.g., from a single a microphone on a headset. In some implementations, a scope of speech for recognition can be reduced by providing for recognition only speech that responds to a prompt from, for example, a

VoiceXML dialogue executing on a speech-enabled device. As the scope of speech for recognition is reduced, data processing burdens can be reduced across the system as a whole. In some implementations, conversations including multiple participants of the conversation can be used for speech for recognition.

In the example of FIG. 1, insight generation is performed using halfalogues of the conversation. For example, less than all the speech of the conversation (313) is used in insight generation. In this example, only a subset of the participants contribute to the speech for recognition, e.g., only the tele-agent (128) contributes speech that will be recorded, digitized, converted to text, and used for insight generation. Such an example is useful in situations where a customer does not consent to having a sales call recorded, when a local jurisdiction of the customer does not allow for recording of a call, or when seeking permission is off-putting or burdensome.

Speech from a tele-agent in the example of FIG. 1 is converted into digitized speech by operation of a natural language processing speech recognition or natural language processing, automatic speech recognition (“NLP-SR” or “NLP-ASR”) engine (153), shown here disposed upon a voice server (151), but also amenable to installation on speech-enabled devices. The NLP-SR engine (153) converts the digitized speech into text, e.g., using speech-to-text conversion methods. The NLP-SR engine then performs a parsing of a word (509) of the text (508) into a triple (752) of a description logic, as described in further detail with reference to FIG. 4 below.

A triple is a three-part statement expressed in a form of logic. Depending on context, different terminologies are used to refer to effectively the same three parts of a statement in a logic. For example, in first order logic, the parts are called constant, unary predicate, and binary predicate. In another example, in the Web Ontology Language (“OWL”) the parts are individual, class, and property. In another example, in some description logics the parts are called individual, concept, and role.

In this example description, the elements of a triple are referred to as subject, predicate, and object—and expressed like this: <subject><predicate><object>. There are many modes of expression for triples. Elements of triples can be represented as Uniform Resource Locaters (“URLs”), Uniform Resource Identifiers (“URIs”), or International Resource Identifiers (“IRIs”). Triples can be expressed in N-Quads, Turtle syntax, TriG, Javascript Object Notation or “JSON,” and the like. The expression used here, subject-predicate-object in angle brackets, is one form of abstract syntax, optimized for human readability rather than machine processing, although its substantive content is correct for expression of triples. Using this abstract syntax, the following are examples of triples:

<Bob> <is a> <person>
<Bob> <is a friend of> <Alice>
<Bob> <is born on> <the 4^{th} of July 1990>
<Bob> <is interested in> <the Mona Lisa>
<the Mona Lisa> <was created by> <Leonardo da Vinci>
<the video ‘La Joconde à Washington’> <is about> <the Mona Lisa>

At times, a same item can be referenced in multiple triples. In the above example, Bob is the subject of four triples, and the Mona Lisa is the subject of one triple and the object of two. The ability to have the same item be the subject of one triple and the object of another makes it possible to effect connections among triples, where connected triples can form graphs, as described in further detail below.

At times, a taxonomy can be generated, e.g., by the client, by the sales-agent, or another third-party, to bias the NLP-SR engine for frequently used (e.g., common) terminology. For example, the taxonomy can include sales related terminology for the client's product lines. Sales related terminology can include standard (e.g., static) vocabulary that can be used as differentiators between different products and product lines for the client. The sales related terminology can be used, by the NLP-SR engine (153) to segregate product-specific vocabulary from the speech contributions.

In some implementations, the taxonomy can include vocabulary files composed of phonetic names built from the existing taxonomy that can be used for phonetic assistance. In other words, the phonemes included in vocabulary files can be used by the NLP-SR engine to recognize and decode words that are expected within the speech contributions, e.g., words associated with the taxonomy more accurately.

Phonetic assistance can be used to assist the NLP-SR engine to handle non-standard speech contributions. For example, to recognize different aliases (e.g., different pronunciations) of the terminology. In some implementations, vocabulary files can include an assembly of phonemes that are specific to the product, product lines, and/or company. For example, the phonemes can be generated for all the stock keeping units (SKUs) for a company. The taxonomy can be generated as a back-end process, e.g., a repository of terminology, vocabulary, phonetic assistance, phonemes, etc., can be stored in the voice server 151 to assist the NLP-SR engine 153 with generation of the halfalogue triples 138 from the converted speech-to-text.

In some implementations, vocabulary files included in a generated taxonomy can assist the NLP-SR engine 153 in differentiating between speech-to-text from various participants of a sales call. For example, the vocabulary files can include vocabulary (e.g., words/phrases), terminology, phonemes, etc., that are specific to halfalogue text, e.g., specific to the speech contribution from the sales agent or a customer. The vocabulary files can include contextual clues, that can aid in grouping together elements and/or parsing of a phrase or sentence that adds contextual meaning. For example, contextual clues can include first person, second person, or third person language, e.g., a speech contribution phrase including “[I] would like to find a solution for [my] problem” where the bracketed words can indicate a customer speech contribution. In another example, “[SRT Company] would like to help [you] find a solution to [your] needs” where the bracketed words can indicate a sales agent contribution.

In some implementations, the NLP-SR engine (153) can use entity extraction based on the stored vocabulary files to select and analyze the contextual clue words/phrases in the speech contributions including standard (e.g., known) taxonomy. For example, the NLP-SR engine can recognize standard taxonomy for a client, e.g., a product name or product line name, and search/select entities referenced in the phrase surrounding the standard taxonomy for contextual clues. For example, a phrase may include “You would like purchase an XYZ product in Ql”, where “XYZ product” is recognized as the standard taxonomy and “you would like to purchase . . . in Ql” can be used to extract additional contextual clues, e.g., a purchase target date range, price points, quantities, configurations of specific products, or the like.

In some implementations, vocabulary files include contextual clue words/phrases that can be used by the NLP-SR engine (153) to differentiate a speaker of the speech contribution. For example, a sales-agent may use rephrasing or confirmation language to relay back information provided by a customer. In instances where the customer speech contribution is not recorded, identifying the rephrasing language can be used by the NLP-SR engine (153) to identify specific information provided to the sales agent by the (non-recorded) customer. For example, a phrase may include “Just to confirm, you would like delivery of QRS products by end of May?” where “Just to confirm” can flag for the NLP-SR engine, e.g., based on a taxonomy specific to sales-agent speech contributions, that this phrase includes a rephrasing/affirmation of a statement made by a (e.g., non-recorded) customer. At times, the NLP-SR engine (153) can bias sampling of the speech contributions based in part on recognizing the contextual clues included the rephrasing/confirmation language. In other words, the NLP-SR engine (153) can adjust (e.g., dynamically) a sampling rate or sampling size based in part on a determined context of the speech contribution statements. The example of FIG. 1 includes a semantic graph database (818) which includes an enterprise knowledge graph (816). A semantic graph is a configuration of memory that uses graph structures, e.g., nodes and edges, to represent and store data. A key concept of this kind of configuration is the graph (or edge or relationship), which directly relates data items in a data store. Data items stored in the knowledge graph can include many-to-many relationships, where a data item can include relationships to multiple other data items such that the relationships between the data item and the multiple different data items can be queried. The semantic graph database (818) can be specifically built around, for example, words, phrases, and dialect. The knowledge graph of the semantic graph database can be built around sentences and natural language processing such that queries of the knowledge graph can be queried and return semantic-based data, e.g., semantic triples. A graph database contrasts with more conventional storage such as a logical table, where links among data can be defined as indirect metadata, and queries can search for data within the store using the indirect metadata, e.g., joins, to collect related data. Semantic graphs, by design, can be utilized to establish explicit relationships amongst data, e.g., that can be otherwise difficult to model in relational systems or logical tables.

In the example of FIG. 1, the semantic graph database (818) includes an enterprise knowledge graph 816 including semantic triple store (814). The semantic triple store (814) includes semantic triples generated by the NLP-SR (153) from speech contributions and are accessible by the intelligence assistant (300), a customer relationship management (CRM) system (806) and other components. The semantic triple store (814) of FIG. 1 can include structured definitions of words, e.g., expected ordering of words, not special to any particular knowledge domain, where each structured definition of the general language store is implemented with a triple of description logic. The structured definitions define syntactical form, e.g., stored in vocabulary files, for the words/phrases extracted from the text generated by the NLP engine from the speech contributions. For example, a structured definition of words stored as a triple of description logic is <“title”, “first name”, “last name”>, which can be an expected form in which a person's name is spoken in a speech contribution. A vocabulary file including phonemes of titles in a taxonomy, e.g., “Mister,” “Miss,” “Miz,”, “Missus,” “Missis”, etc., can be used to decode the speech contribution and correctly identify the title being spoken. The semantic triple store (814) also includes structured definitions of words, e.g., taxonomies described above, that can be specific to processing particular knowledge domains. For example, a structured definition can include an expected phrasing/arrangement of words for products, jargon of an industry, particular industries, geographic areas, etc., spoken during a speech contribution. A vocabulary file can include phonemes of the taxonomy specific to the particular knowledge domains, where the vocabulary of the product triple store is implemented with a triple of description logic.

The semantic triple store (814) of FIG. 1 includes halfalogue triples (138) stored in the enterprise knowledge graph 816. A halfalogue triple is a triple created from a halfalogue, e.g., speech contribution from fewer than all the participants from a conversation. Halfalogue triples can be generated from speech contributions of a sales agent, where the NLP-SR engine (153) may identify the speech contribution as a halfalogue based in part on identifying vocabulary, e.g., contextual clues, that is specific to a halfalogue. Such halfalogue triples are so designated such that processing and insight generation can proceed knowing the triples were created from only a portion of a conversation.

The semantic triple store (814) in the example of FIG. 1 includes triples defining various forms of information useful in insight generation according to embodiments of the present technology. Such triples may be queried by an intelligence assistant engine to retrieve insights. For example, triples can be queried, e.g., by a user of the intelligence assistant, to prepare call notes parsed into semantic triples, identify customer connections, identify relevant use cases, identify chats, identify installed technology of a customer, produce talk tracks, and identify product recommendations. The intelligence assistant can, in response to a user-provided query, generate a structured query to search the knowledge graph and generate a representation of the returned data in response to the query. The representation of the data responsive to the query can be, for example, a graphical, audio, video, spreadsheet, etc. representation of the data. For example, the representation of the data can include one or more plots including analysis of the data responsive to the query. In another example, the representation of the data can include one or more audio clips from recorded speech contributions (e.g., halfalogues) for sale calls. At times, raw data responsive to the query can be provided, such that a user may perform a separate analysis step on the raw data.

The information stored in knowledge graph (816) of FIG. 1 is presented for explanation and not for limitation. The enterprise knowledge graph may be used to store other information useful in insight generation according to embodiments of the present technology.

The example of FIG. 1 also includes an intelligence assistant (300). The intelligence assistant of FIG. 1 is a speech-enabled platform capable of insight generation and management of the semantic graph database as discussed in more detail below with reference to FIG. 4. The intelligence assistant (300) includes a customer relationship management (CRM) (806). The CRM (806) is a CRM system configured for the use of tele-agents and other users of the enterprise. Often data stored on and accessed by the CRM is data owned by the enterprise itself and collected over time for the use of various users of the organization. In other embodiments of the present technology, the CRM may be owned by a client of the call center and the data residing in that CRM is owned by the client.

In some implementations, intelligence assistant (300) and CRM (806) can be hosted by an enterprise server (820), e.g., also hosting a triple server (157). The intelligence assistance (300) can be in data communication with additional servers, for example, a voice server (151), a lead engine (134), a social media server (130), and an industry server (130).

In some implementations, the intelligence assistant can be configured to request leads from a third-party operating the lead engine (134). Such leads may provide information regarding customers. For example, including contact information, key employees, site locations, and other information regarding the customer. The leads can be parsed into semantic triples, e.g., by the intelligence assistant, and stored in the semantic triple store (814) of the enterprise knowledge graph (816).

In some implementations, the intelligence assistant (300) of FIG. 1 is connected for data communications with one or more social media servers (130). Such social media servers are often implemented by third parties and often provide information and insight about their users. In the example of FIG. 1, the intelligence assistant (300) may request information directly from the social media servers or indirectly throughout the CRM and parse the information into semantic triples for storage in the semantic triple store of the enterprise knowledge graph.

in some implementations, the intelligence assistant (300) 1 is connected for data communications with one or more industry servers. Such servers are often operated by third parties and can provide current and historic information regarding a particular industry, e.g., for companies in various industries. In the example of FIG. 1, the intelligence assistant (300) may receive information directly from the industry servers or indirectly through the CRM and parse the information into semantic triples for storage in the semantic triple store of the enterprise knowledge graph.

The use of a lead server (824), social media server (826) and the industry server (828) in the example of FIG. 1 is for explanation and not for limitation. In some implementations, halfalogue insight generation may make use of many third-party systems or internal systems.

In the example of FIG. 1, many components useful in insight generation according to embodiments of the present technology are maintained in computer memory (159). In the example of FIG. 1, computer memory (159) includes cache, random access memory (“RAM”), disk storage, and so on, most forms of computer memory. Computer memory (159) so configured typically resides on speech-enabled devices, or as shown here, upon one or more triple servers (157), voice servers, or enterprise servers (820)

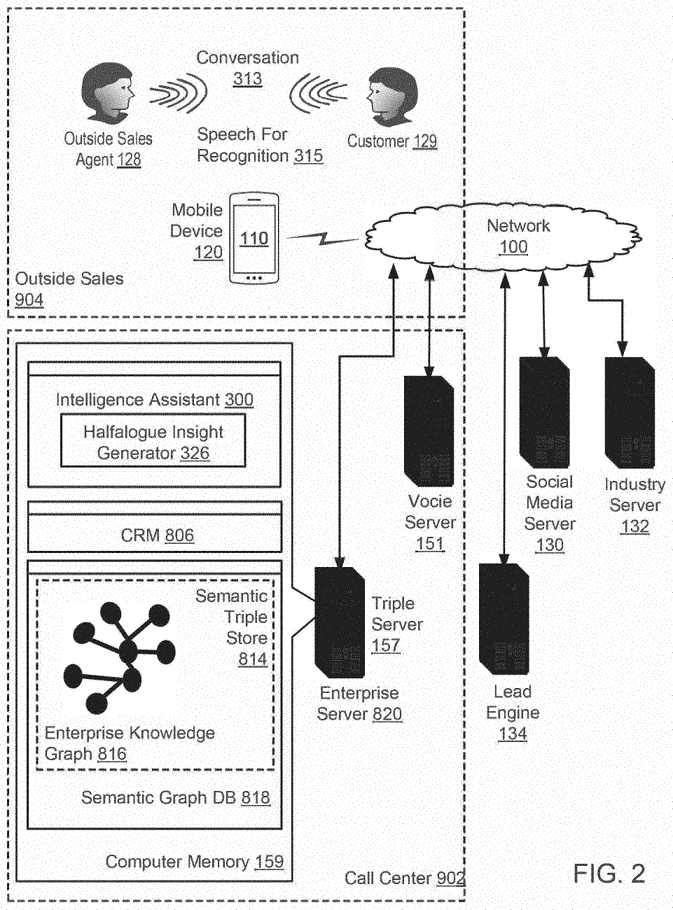

In some implementations, halfalogue insight generation can be used, for example, by a sales-agent performing outside sales. For further explanation, FIG. 2 sets forth a network diagram illustrating a system for halfalogue insight generation, e.g., for supporting outside sales. Halfalogue insight generation in the example of FIG. 2 is implemented with at least one speech-enabled mobile device (120), a triple server (157), a voice server (151), and an intelligence assistant (300).

The example of FIG. 2 depicts elements of outside sales (904) and a call center (902) according to embodiments of the present technology. In the example of FIG. 2, an outside sales agent (128) is engaged in a sales call with a customer (129). The sales call includes a conversation (313), at least a portion of which is received on a mobile device (120). In some embodiments, only speech from the outside sales agent (128) is used to generate real-time halfalogue insights. The outside sales agent (128) receives the real-time halfalogue insights, e.g., through a mobile device of the sales agent and is empowered to use these insights to improve both efficacy and efficiency of the outside sales call.

In the example of FIG. 1, the intelligence assistant (300) operates remotely, e.g., operates on a cloud-based server in data communication with the mobile device (120) of the agent (128) over network (100), and provides, e.g., through a user interface dashboard presented on the mobile device (120), a speech-enabled platform capable of insight generation and management of the semantic graph database as discussed in more detail below with reference to FIG. 4.

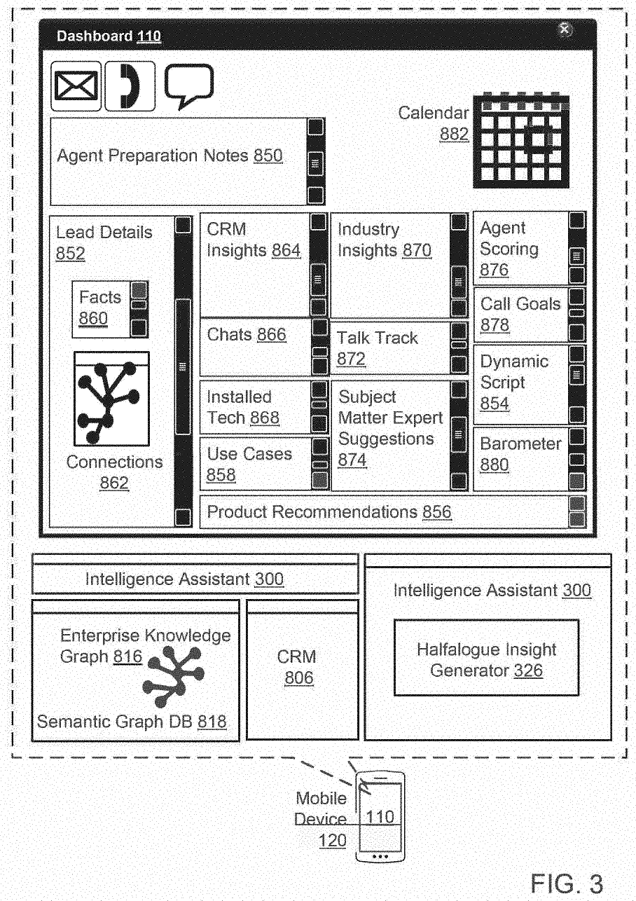

For further explanation, FIG. 3 sets forth a line drawing of an example system for halfalogue insight generation and presentation according to embodiments of the present technology. Halfalogue insights generated by the system can be presented in an agent dashboard (110) which can provide the insights for use by the agent before, during, or after a communication with a customer. Although depicted in FIG. 3 as a dashboard viewable on a mobile device (120), an agent may view and interact with the agent dashboard (110) on another device, for example, a tablet, computer, or the like. The example of FIG. 3 includes a semantic graph database (818) which includes an enterprise knowledge graph (816). The semantic graph database (818) and enterprise knowledge graph (816) maintains a data store of semantic triples including proprietary and non-proprietary information. The semantic triples include for example, among other things, customer information, industry information, products that may be discussed between a sales agent and customers, recommended products for the customer, and sales agent notes for use during the call. For example, relevant information for the customer, e.g., an industry of the customer, may surface during a conversation with the sales agent and can be stored in the knowledge graph.

Such information may be provided to the sales agent through an agent dashboard (110) presented on an agent's device, e.g., mobile device (120). An agent dashboard may be implemented as a thin-client operating architecture, for example, as a web browser that implements HTTP communications with an intelligence assistant that provides insight generation according to embodiments of the present technology. In such a thin-client architecture, the intelligence assistant (300), the semantic graph database (818), the CRM (806) and the intelligence assistant (300) operate remotely, e.g., on enterprise server (820) in data communication with the sales-agent mobile device (120) through network (100).

In some implementations, as depicted in FIG. 3, the dashboard (11) includes features related to CRM (806), where the CRM insights (864) includes proprietary and non-proprietary information regarding, for example, customer information, industry information, products that may be discussed between a sales agent and customers, recommended products for the customer, and tele-agent notes for a customer generated during a sales call. Such information may be displayed to the sales agent on the dashboard (110) of the mobile device.

The example of FIG. 3 includes an intelligence assistant (300), a targeted collection of artificial intelligence-based technologies including natural and semantic language processing that processes unstructured communications into structured information, e.g., semantic triples, and that generates, in dependence upon the structured information and CRM data, insights available to the sales agent through the mobile device ultimately driving improved quality and efficiency. The intelligence assistant (300) administers an enterprise knowledge graph (816) of a semantic graph database (818) that houses structured data in the form of semantic triples optimized for insight generation.

In the example of FIG. 3, the sales agent is provided real-time insights, real-time customer and product information displayed through the dashboard (110) for use by the sales agent during the conversation with the customer. In the example of FIG. 3, the speech-enabled dashboard (110) includes a widget for the display of call preparation notes (850). Such call notes may be prepared or supplemented by the agent before, during, or after a conversation with the customer.

Widgets in this disclosure are implemented as software applications or components that perform one or more tasks and whose execution is administered by the intelligence assistant. Each of the widgets described in this disclosure have an accompanying GUI element configured to be (e.g., optionally) displayed in the dashboard (110) as illustrated in FIG. 3. The example widgets and their associated GUI elements are for explanation and not for limitation. In fact, insight generation according to embodiments of the present technology may administer widgets that have no GUI elements or have more than one GUI element.

In the example of FIG. 3, the dashboard (110) includes a widget for the display of the lead details (852) including information describing the customer and customer's business often including name and contact information of the customer, the industry supported by the customer, the locations the customer conducts business, and other useful information that may be included in a listing of facts (860) about the customer. The dashboard (110) of FIG. 3 also displays a connections image (862) that provides to the tele-agent (128) any known connections between the customer and other customers, or people or organizations traced within the CRM (806).

In the example of FIG. 3, the dashboard (110) includes a widget for the display of a calendar (882) and widget for CRM insights (864) displaying insights regarding the customer known or derived by the CRM (806). In the example of FIG. 3, the dashboard (110) includes a widget for the display of the technology (858) currently installed in the customer's sites and locations useful in discussing products that are compatible with that installed technology with the customer.

In the example of FIG. 3, the dashboard (110) includes a widget for the display of use cases (858) describing the product that may be useful to the agent during a conversation with the customer. For example, use cases can be provided by clients of the call center or clients of the sales agent to better inform customers about the products the client sells. Similarly, such clients may provide other collateral information that may be useful in communicating with the customer, for example, relevant industries for the customer.

In the example of FIG. 3, the dashboard (110) includes a widget for the display of product recommendations (856) for the customer and a display of competing products (868) that may be sold by competitors that are compatible with the currently installed technology already in use by the customer. These product recommendations may be useful to an agent (128) in preparation for or during a conversation with the customer. Such product recommendations may be provided by the semantic graph database (818), the CRM (806) or from other sources.

In the example of FIG. 3, the dashboard (110) includes a widget for the display of industry insights. Industry insights may include current trends in the customer's industry, newly available products for use in an industry, current news regarding the industry and so on. Such insights may be stored and managed by the semantic graph database (818), the CRM (806), or provided from third parties such as third parties operating industry servers, social media servers, lead servers, etc.

In the example of FIG. 3, the dashboard (110) includes a widget for the display of a talk track. The talk track includes a campaign specific introduction for use by an agent with the customer and optionally additional talking points for the agent. In some cases, an agent may want to customize a talk track to include preferred vernacular, style, and other attributes. The talk track is editable in the example of FIG. 3 by the agent through speech, use of a user interface, use of a keyboard, and in other ways.

In the example of FIG. 3, the dashboard (110) includes a widget for the display of subject matter expert suggestions (874). Subject matter expert suggestions (874) may be provided in real-time or maintained by the semantic graph database (818), the CRM (806), or from other sources. Subject matter expert suggestions may be provided by internal subject matter experts or by third-party subject matter experts or in other ways.

In the example of FIG. 3, the dashboard (110) includes a widget for agent scoring (876). An agent score may represent the agent's place along a defined sales cycle of a campaign, the agent's rank among other agents in the enterprise, as well as other ways of scoring the agent. Such an agent score may be developed and maintained by the semantic graph database (818), the CRM (806), or other components.

In the example of FIG. 3, the dashboard (110) includes a widget for the display of sales call goals (878) for the agent. Such sales call goals are often related to the agent's place in a sales cycle defined for the campaign.

In the example of FIG. 3, the dashboard (110) includes a widget for the display of a dynamic script (854) often created in real-time as a guidance and aid for the agent in the conversation with the customer. Such a script may be created by the CRM (806), intelligence assistant (300), or other components based upon the current sales campaign, information relating to the customer, historic sales trends, success stories of agents and other factors associated with similar sales campaigns.

In the example of FIG. 3, the dashboard (110) includes a widget for the display of a barometer (881) the barometer is graphical representation or text display providing the agent with an indication of the current performance of the agent servicing a particular sales campaign. Such a barometer may be created by a CRM (806), an intelligence assistant (300), or other components based on many factors such as the goals of the sales campaign, the performance of the tele-agent or other the tele-agents servicing the sales campaign and other factors associated with the sales campaign.

The components and widgets presented in the example of FIG. 3 are for explanation and not for limitation. Components and widgets, as well as the functions they perform and information they provide may vary dramatically among various embodiments of the present technology. All such components and widgets whatever their form may be used for insight generation according to various embodiments of the present technology.

For further explanation, FIG. 4 sets forth a system diagram illustrating a system for halfalogue insight generation according to embodiments of the present technology. The system of FIG. 4 includes an enterprise server (820). The example enterprise server of FIG. 4 can be implemented as one or more computers, e.g., one or more cloud-based servers, that stores programs serving the collective needs of an enterprise rather than a single user or a single department. An enterprise server can refer to both the computer hardware and its main software, e.g., operating system. Enterprise server (820), in the example system of FIG. 4, can host an intelligence assistant (300) that includes a channel engine (800), a triple parser and serializer (320), and a halfalogue insight generator (326)). In some implementations, the enterprise server (820) can host a speech engine (153) and a semantic graph database (880)

The semantic graph database (880) of FIG. 4 is a type of graph database that integrates heterogeneous data from many sources and establishes links between datasets. The knowledge graph includes relationships between entities and can be used, e.g., by the intelligence assistance (300) to infer new knowledge out of existing information. The semantic technology of FIG. 4 can be used to link new information automatically, without manual user intervention or the database being explicitly pre-structured. This automatic linking can be used to integrate data from inside and outside company databases, for example, corporate email, documents, spreadsheets, customer support logs, relational databases, government/public/industry repositories, news feeds, customer data, social networks, and the like. In traditional relational databases this linking can involve complex coding, data warehouses and heavy pre-processing with exact a priori knowledge of the types of queries to be asked.

The semantic graph database (880) of FIG. 4 includes a database management system ‘DBMS’ (865) and data storage (870). The DBMS of FIG. 4 includes an enterprise knowledge graph (816) and a query engine (853). The enterprise knowledge graph of FIG. 4 is a structured representation of data stored in data storage (870), e.g., semantic triple store 814. The query engine of FIG. 4 receives structured queries, e.g., from a user of intelligence assistant (300), and retrieves stored information in response. Structured queries can be generated, for example, by a structured query interface (e.g., SPARQL) from a user-provided query. The structured queries can be generated by the structured query interface to be compatible with searching the knowledge graph. Further details related to the query engine are described with reference to FIG. 4 below.

The system of FIG. 4 includes a speech engine (153). The example speech engine includes a natural language processing (NLP) engine and automatic speech recognition (ASR) engine (e.g., also referred to herein as “NLP-SR” engine) for speech recognition and text-to-speech (‘TTS’) for generating textual transcription of speech contributions. At times, the NLP-SR engine (153) is configured to access a repository of taxonomy, e.g., vocabulary files, that can be used to process the speech contributions. The example speech engine (153) includes a grammar module (104), a lexicon module (106), and a language-specific acoustic model (108) as discussed in more detail below.

The intelligence assistant (300) of FIG. 4 includes a channel engine (360), a module of automated computing machinery that administers communications over disparate communications channels such that information may be ingested into the intelligent assistant without limitation to its original form or communications channel. The channel engine (360) establishes communications sessions using disparate protocols such as SMS, HTTP, VOIP and other telephony, POTS, email, text streams, static text, etc.

In the example of FIG. 4, the channel engine (360) is configured to administer communications through chat (302) and chatbots (308) using, for example, instant messaging protocols such as SMS, Bonjour, MSNP, etc. The example channel engine (360) administers communications with email (304) using various email protocols such as IMAP, POP3, SMTP, Exchange, and others. The example channel engine (360) may administer communications using voice over Internet Protocol (‘VOIP’) communications with live, recorded, or automated participants. The communications channel may also administer communications with engines, services, and other resources to retrieve static call notes (310), communicated with a CRM (312) static catalogs (314), sales engines (316), lead engines (318), and other resources such as using API's or other invocation methods.

Communications administered by the communications engine may be text-based and often that text is maintained to be ingested by the intelligence assistant. Other communications may be live or recorded speech which is converted to text by the speech engine (153) for consumption by the intelligence assistant.

The channel engine (360) provides an always-on communications listener (330) that listens over each of the communications channels and provides the communication for use by the intelligence engine. Once the communications are received by the intelligence assistant, the text is then parsed into semantic triples, e.g., using the NLP-SR engine (153), such that the information may be usefully used to identify sales insights. The enterprise server (820) of FIG. 4 includes a triple parser and serializer (306). The triple parser and serializer (306) can be, as depicted in FIG. 4, a part of the intelligence assistant (300). At times, voice server (e.g., voice server (151) depicted in FIG. 1, can perform the actions described with reference to the triple parser and serializer (306). The triple parser of FIG. 4 takes as input a file in some format, for example, such as the standard RDF/XML format, which is compatible with the more widespread XML standard. The triple parser receives a file as input and converts it into an internal representation of the triples that are expressed in that file as output. At this point, the triples are stored in the triple store (814) can be available for all the operations of the store. Triples parsed and stored in the triple store can be serialized back out using the triple serializer (306).

The triple parser of FIG. 4 creates triples based upon a taxonomy (322) and an ontology (324). The taxonomy (322), e.g., as described above with reference to FIG. 1, includes words or sets of words with defined semantics that will be stored as triples. To parse speech into semantic triples the triple parser receives text converted from speech by the speech engine and identifies portions of that text that correspond with the taxonomy and forms triples using the defined elements of the taxonomy.

The triple parser of FIG. 4 also creates triples in dependence upon an ontology (324). An ontology is a formal specification that provides sharable and reusable knowledge representation. An ontology specification includes descriptions of concepts and properties in a domain, relationships between concepts, constraints on how the relationships can be used and other concepts and properties.

The enterprise server (820) of FIG. 4 includes a CRM (806), automated computing machinery that provides contact management, sales management, agent productivity administration, and other services targeted to improved customer relations and ultimately customer satisfaction and enterprise profitability. The example CRM of FIG. 4 can be used to manage customer relationships across the entire customer lifecycle, individual sales cycles, campaigns, driving marketing, sales, and customer service and so on. Such information is received, parsed, and stored by the intelligence assistant for use in generating insights according to embodiments of the present technology.

The intelligence assistant (300) of FIG. 4 includes a halfalogue insight generator (326). The insight generator (326) of FIG. 4 queries the query engine (853) of the semantic graph database (880) and identifies insights in dependence upon the results of the queries. Insight generators according to embodiments of the present technology often generate queries using a query language. Query languages may be implemented as an RDF query language such as SPARQL.

In some embodiments of the present technology, insights may be selected from predefined insights meeting certain criteria of the search results or may be formed from the query results themselves. Such insights may be useful to a sales agent during a conversation with a customer. Examples of insights useful according to embodiments of the present technology include information about an industry, a customer job title, insights relating to budget, authority, need, and time (‘BANT’), cost and pricing information, competitive products, positive or negative sentiment in call, chat, email or other communication, identification of key individuals, targets reached, contacts reached, industry terms, next best action for a tele-agent, product recommendations, custom metrics, etc.

The intelligence assistant (300) of FIG. 4 includes a third-party data retrieval module (380). The third-party data retrieval module (380) of FIG. 4 is a module of automated computing machinery configured to retrieve information from third-party resources such as industry servers, social media servers, clients, customers, and other resources.

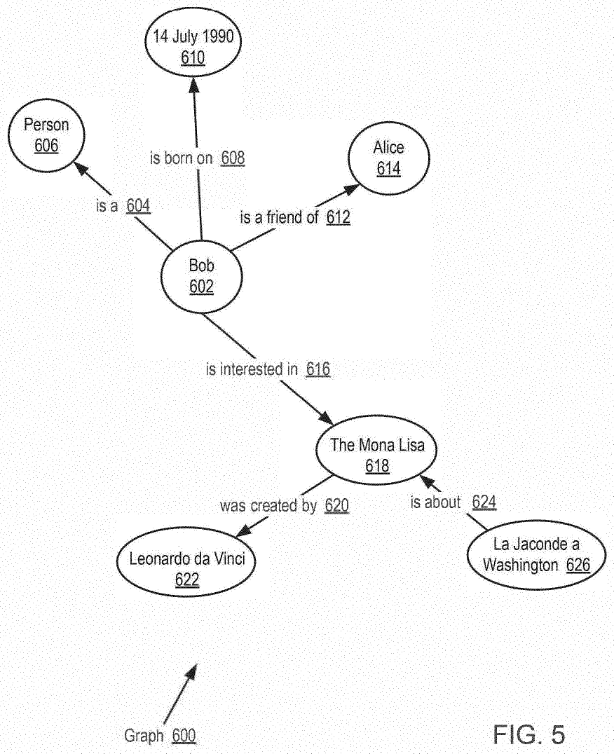

For further explanation of relations among triples and graphs, FIG. 5 sets forth a line drawing of a graph (600). The example graph of FIG. 5 implements in graph form the example triples set forth above regarding Bob and the Mona Lisa. In the example of FIG. 5, the graph edges (604, 608, 612, 616, 620, 624) represent respectively relations among the node, that is, represent the predicates < is a>, < is a friend ofd, <is born on>, <is interested in>, <was created by>, and <is about>. The nodes themselves represent the subjects and objects of the triples, <Bob>, <person>, <Alice>, <the 4th of July 1990>, <the Mona Lisa>, <Leonardo da Vinci>, and <the video ‘La Joconde à Washington’>.

In systems of knowledge representation, knowledge can be represented in graphs of triples, including, for example, knowledge representations implemented in Prolog databases, Lisp data structures, or in RDF-oriented ontologies in RDFS, OWL, and other ontology languages. Search and inference are effected against such graphs by search engines configured to execute semantic queries in, for example, Prolog or SPARQL. Prolog is a general-purpose logic programming language. SPARQL is a recursive acronym for “SPARQL Protocol and RDF Query Language.” Prolog supports queries against connected triples expressed as statements and rules in a Prolog database. SPARQL supports queries against ontologies expressed in RDFS or OWL or other RDF-oriented ontologies. Prolog, SPARQL, RDF, these are provided as non-limiting examples of technologies that can be used in example embodiments of the present technology. Knowledge representations useful according to embodiments of the present technology can take various forms, now or in the future, and all such are now and will continue to be within the scope of the technology described herein.

A description logic is a member of a family of formal knowledge representation languages. Some description logics are more expressive than propositional logic but less expressive than first-order logic. In contrast to first-order logics, reasoning problems for description logics are usually decidable. Efficient decision procedures therefore can be implemented for problem of search and inference in description logics. There are general, spatial, temporal, spatiotemporal, and fuzzy descriptions logics, and each description logic features a different balance between expressivity and reasoning complexity by supporting different sets of mathematical constructors.

Search queries are disposed along a scale of semantics. A traditional web search, for example, is disposed upon a zero point of that scale, no semantics, no structure. A traditional web search against the keyword “derivative” returns HTML, documents discussing the literary concept of derivative works as well as calculus procedures. A traditional web search against the keyword “differential” returns HTML pages describing automobile parts and calculus functions.

Other queries are disposed along mid-points of the scale, some semantics, some structure, not entirely complete. Such systems may be termed executable rather than decidable. From some points of view, decidability is not a primary concern. In many Web applications, for example, data sets are huge, and they simply do not require a 100 percent correct model to analyze data that may have been spidered, scraped, and converted into structure by some heuristic program that itself is imperfect.

Other classes of queries are disposed where correctness of results is key, and decidability enters. A user who is a tele-agent in a data center speaking by phone with an automotive customer discussing a front differential is concerned not to be required to sort through calculus results to find correct terminology. Such a user needs correct definitions of automotive terms, and the user needs query results in conversational real time, that is, for example, within seconds.

In formal logic, a system is decidable if there exists a method such that, for every assertion that can be expressed in terms of the system, the method can decide whether or not the assertion is valid within the system. In practical terms, a query against a decidable description logic will not loop indefinitely, crash, fail to return an answer, or return a wrong answer. A decidable description logic supports data models or ontologies that are clear, unambiguous, and machine-processable. Undecidable systems do not. A decidable description logic supports algorithms by which a computer system can determine equivalence of classes defined in the logic.

Undecidable systems do not. Decidable description logics can be implemented in C, C++, SQL, Lisp, RDF/RDFS/OWL, and so on. In the RDF space, subdivisions of OWL vary in decidability. Full OWL does not support decidability. OWL DL does.

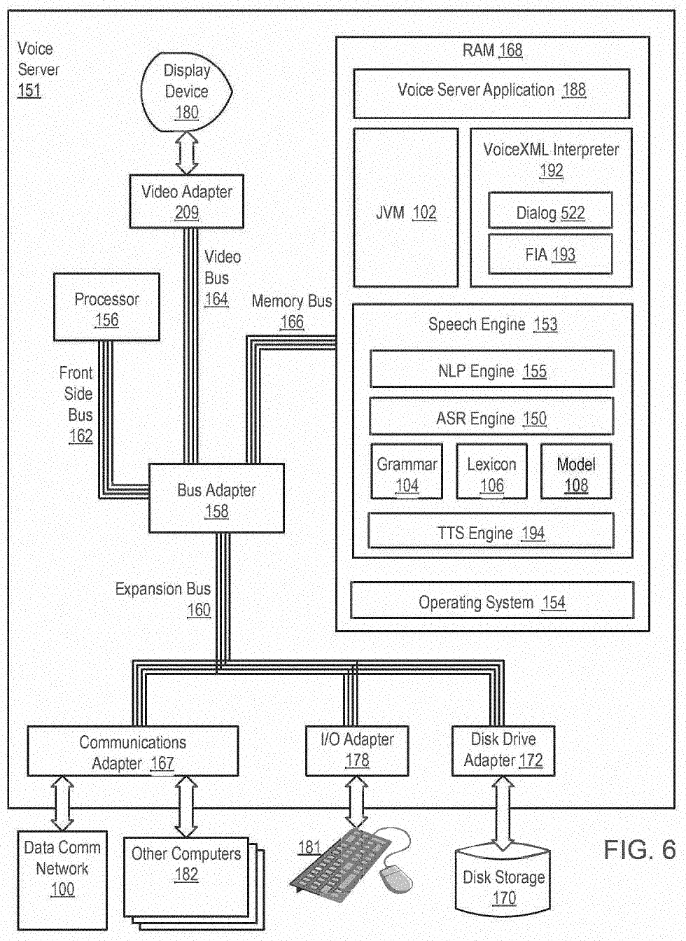

Halfalogue insight generation according to embodiments of the present technology, particularly in a thin-client architecture, may be implemented with one or more voice servers. A voice server can be implemented on one or more computers, that is, automated computing machinery, that is configured to provide speech recognition and speech synthesis. FIG. 6 sets forth a block diagram of automated computing machinery comprising an example of a computer useful as a voice server (151) for a speech-enabled device useful according to embodiments of the present technology. The voice server (151) of FIG. 6 includes at least one computer processor (156) or ‘CPU’ as well as random access memory (168) (‘RAM’) which is connected through a high-speed memory bus (166) and bus adapter (158) to processor (156) and to other components of the voice server.

Stored in RAM (168) is a voice server application (188), a module of computer program instructions capable of operating a voice server in a system that is configured for use in configuring memory according to some embodiments of the present technology. Voice server application (188) provides voice recognition services for multimodal devices by accepting requests for speech recognition and returning speech recognition results, including text representing recognized speech, text for use as variable values in dialogs, and text as string representations of scripts for semantic interpretation. Voice server application (188) also includes computer program instructions that provide text-to-speech (‘TTS’) conversion for voice prompts and voice responses to user input in speech-enabled applications such as, for example, speech-enabled browsers, X+V applications, SALT applications, or Java Speech applications, and so on.

Voice server application (188) may be implemented as a web server, implemented in Java, C++, Python, Perl, or any language that supports X+V, SALT, VoiceXML, or other speech-enabled languages, by providing responses to HTTP requests from X+V clients, SALT clients, Java Speech clients, or other speech-enabled client devices. Voice server application (188) may, for a further example, be implemented as a Java server that runs on a Java Virtual Machine (102) and supports a Java voice framework by providing responses to HTTP requests from Java client applications running on speech-enabled devices. And voice server applications that support embodiments of the present technology may be implemented in other ways, and such ways are within the scope of the present technology.

The voice server (151) in this example includes a natural language processing speech recognition (“NLP-SR”) engine (153). An NLP-SR engine is sometimes referred to in this disclosure simply as a ‘speech engine.’ A speech engine is a functional module, typically a software module, although it may include specialized hardware also, that does the work of recognizing and generating human speech. In this example, the speech engine (153) is a natural language processing speech engine that includes a natural language processing (“NLP”) engine (155). The NLP engine accepts recognized speech from an automated speech recognition (‘ASR’) engine, processes the recognized speech into parts of speech, subject, predicates, object, etc., and then converts the recognized, processed parts of speech into semantic triples for inclusion in triple stores.

The speech engine (153) includes an automated speech recognition (‘ASR’) engine for speech recognition and a text-to-speech (‘TTS’) engine for generating speech. The language-specific acoustic model (108) is a data structure, a table or database, for example, that associates speech feature vectors (‘SFVs’) with phonemes representing pronunciations of words in a human language often stored in a vocabulary file. The lexicon module (106) is configured to associate words in text form with phonemes representing pronunciations of each word; the lexicon module effectively identifies words that are capable of recognition by an ASR engine. Also stored in RAM (168) is a Text-To-Speech (‘TTS’) Engine (194), a module of computer program instructions that accepts text as input and returns the same text in the form of digitally encoded speech, for use in providing speech as prompts for and responses to users of speech-enabled systems.

The grammar module (104) is configured to provide, to the ASR engine (150), a set of words and sequences of words that currently may be recognized from the input speech. In some implementations, lexicon module (106) associates the words that the ASR engine recognizes with phonemes. The grammar module selects the words currently eligible for recognition. The two sets of words identified by the grammar module and lexicon module at any time may be a same set of words or different sets of words.

Grammars selected by the grammar module may be expressed in several formats supported by ASR engines, including, for example, the Java Speech Grammar Format (USGF′), the format of the W3C Speech Recognition Grammar Specification (‘SRGS’), the Augmented Backus-Naur Format (‘ABNF’) from the IETF's RFC2234, in the form of a stochastic grammar as described in the W3C's Stochastic Language Models (N-Gram) Specification, and in other grammar formats. Grammars typically operate as elements of dialogs, such as, for example, a VoiceXML <menu> or an X+V<form>. A grammar's definition may be expressed in-line in a dialog. Or the grammar may be implemented externally in a separate grammar document and referenced from with a dialog with a URI. The example below exemplifies a grammar expressed in JSFG:

```
<grammar scope=“dialog” ><![CDATA[
  #JSGF V1.0;
  grammar command;
  <command> = [remind me to] call | phone | telephone <name>
  <when>;
  <name> = bob | martha | joe | pete | chris | john | harold;
  <when> = today | this afternoon | tomorrow | next week;
  ]]>
</grammar>
```

In this example, the elements named <command>, <name>, and <when> are rules of the grammar. Rules are a combination of a rulename and an expansion of a rule that advises an ASR engine or a voice interpreter which words presently can be recognized. In this example, expansion includes conjunction and disjunction, and the vertical bars ‘1’ mean ‘or.’ An ASR engine or a voice interpreter processes the rules in sequence, first <command>, then <name>, then <when>. The <command> rule accepts for recognition ‘call’ or ‘phone’ or ‘telephone’ plus, that is, in conjunction with, whatever is returned from the <name> rule and the <when> rule. The <name> rule accepts ‘bob’ or ‘martha’ or ‘joe’ or ‘pete’ or ‘chris’ or ‘john’ or ‘harold’, and the <when> rule accepts ‘today’ or ‘this afternoon’ or ‘tomorrow’ or ‘next week.’

The command grammar as a whole matches utterances like these, for example:
“phone bob next week,”
“telephone martha this afternoon,”
“remind me to call chris tomorrow,” and
“remind me to phone pete today.”

The voice server application (188) in this example is configured to receive, from a speech-enabled client device located remotely and in data communication with the voice server through network 100, digitized speech for recognition from a user and pass the speech along to the ASR engine (150) for recognition. In carrying out automated speech recognition, the ASR engine receives speech for recognition in the form of at least one digitized word and uses frequency components of the digitized word to derive a speech feature vector or SFV. An SFV may be defined, for example, by the first twelve or thirteen Fourier or frequency domain components of a sample of digitized speech. The ASR engine can use the SFV to infer phonemes for the word from the language-specific acoustic model (108). The ASR engine then uses the phonemes to find the word in the lexicon (106).

Also stored in RAM is a VoiceXML interpreter (192), a module of computer program instructions that processes VoiceXML grammars. VoiceXML input to VoiceXML interpreter (192) may originate, for example, from VoiceXML clients running remotely on speech-enabled devices, from X+V clients running remotely on speech-enabled devices, from SALT clients running on speech-enabled devices, from Java client applications running remotely on multimedia devices, and so on. In this example, VoiceXML interpreter (192) interprets and executes VoiceXML segments representing voice dialog instructions received from remote speech-enabled devices and provided to VoiceXML interpreter (192) through voice server application (188).

A speech-enabled application may provide voice dialog instructions, VoiceXML segments, VoiceXML <form> elements, and the like, to VoiceXML interpreter (149) through data communications across a network with such a speech-enabled application. The voice dialog instructions include one or more grammars, data input elements, event handlers, and so on, that advise the VoiceXML interpreter how to administer voice input from a user and voice prompts and responses to be presented to a user. The VoiceXML interpreter administers such dialogs by processing the dialog instructions sequentially in accordance with a VoiceXML Form Interpretation Algorithm (FIX) (193). The VoiceXML interpreter interprets VoiceXML dialogs provided to the VoiceXML interpreter by a speech-enabled application.

As mentioned above, a Form Interpretation Algorithm (‘FIA’) drives the interaction between the user and a speech-enabled application. The FIA is generally responsible for selecting and playing one or more speech prompts, collecting a user input, either a response that fills in one or more input items, or an execution of an event, and interpreting actions that pertained to the newly filled-in input items. The FIA also handles speech-enabled application initialization, grammar activation and deactivation, entering and leaving forms with matching utterances and many other tasks. The FIA also maintains an internal prompt counter that is increased with each attempt to provoke a response from a user. That is, with each failed attempt to prompt a matching speech response from a user an internal prompt counter is incremented.

Also stored in RAM (168) is an operating system (154). Operating systems useful in voice servers according to embodiments of the present technology include UNIX™, Linux_{TM}, Microsoft NT_{TM}, AIX_{TM}, IBM's i5/OS_{TM}, and others. Operating system (154), voice server application (188), VoiceXML interpreter (192), ASR engine (150), JVM (102), and TTS Engine (194) in the example of FIG. 6 are shown in

RAM (168). In some implementations, one or more of the components depicted in FIG. 6 can be stored in non-volatile memory also, for example, on a disk drive (170).

Voice server (151) of FIG. 6 includes bus adapter (158), a computer hardware component that contains drive electronics for high-speed buses, the front side bus (162), the video bus (164), and the memory bus (166), as well as drive electronics for the slower expansion bus (160). Examples of expansion buses useful in voice servers according to embodiments of the present technology include Industry Standard Architecture (ISA′) buses and Peripheral Component Interconnect (PCP) buses.

Voice server (151) of FIG. 6 includes disk drive adapter (172) coupled through expansion bus (160) and bus adapter (158) to processor (156) and other components of the voice server (151). Disk drive adapter (172) connects non-volatile data storage to the voice server (151) in the form of disk drive (170). Disk drive adapters useful in voice servers include Integrated Drive Electronics (IDE′) adapters, Small Computer System Interface (SCSI′) adapters, etc. In addition, non-volatile computer memory may be implemented for a voice server as an optical disk drive, electrically erasable programmable read-only memory (so-called ‘EEPROM’ or ‘Flash’ memory), RAM drives, and so on.

The example voice server of FIG. 6 includes one or more input/output (′I/O′) adapters (178). I/O adapters in voice servers implement user-oriented input/output through, for example, software drivers and computer hardware for controlling output to display devices such as computer display screens, as well as user input from user input devices (181) such as keyboards and mice. The example voice server of FIG. includes a video adapter (209), which is an example of an I/O adapter specially designed for graphic output to a display device (180) such as a display screen or computer monitor. Video adapter (209) is connected to processor (156) through a high-speed video bus (164), bus adapter (158), and the front side bus (162), which is also a high-speed bus.

The example voice server (151) of FIG. 6 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways. Communications adapters implement the hardware level of data communications through which one computer sends data communications to another computer, directly or through a data communications network. Examples of communications adapters useful for embodiments of the present technology include modems for wired dial-up communications, Ethernet (IEEE 802.3) adapters for wired data communications network communications, and 802.11 adapters for wireless data communications network communications.

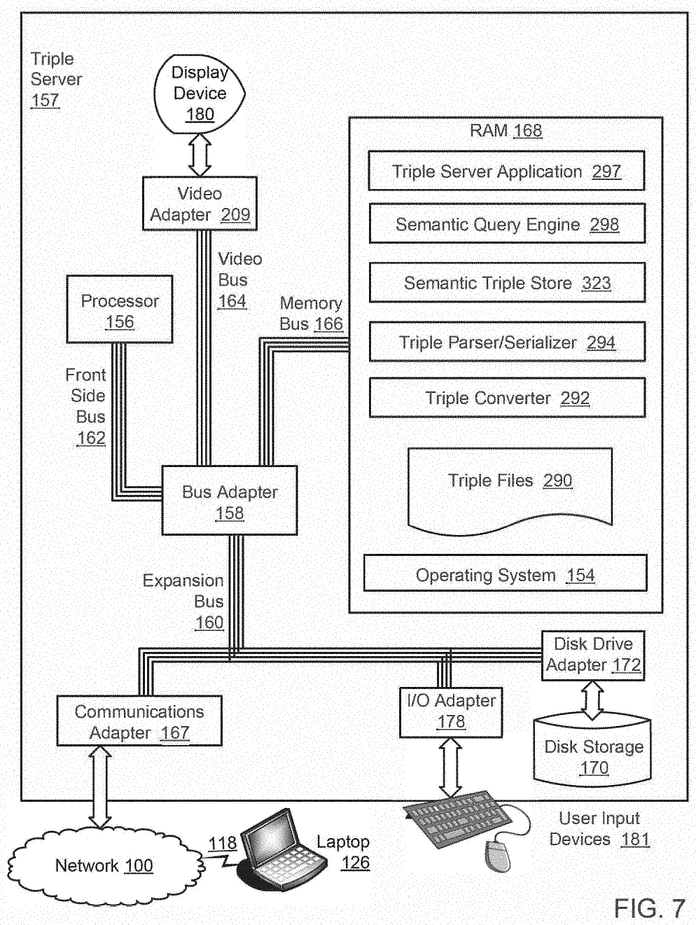

For further explanation, FIG. 7 sets forth a block diagram of automated computing machinery comprising an example of a computer useful as a triple server (157) for insight generation according to embodiments of the present technology. The triple server (157) of FIG. 7 includes at least one computer processor (156) or ‘CPU’ as well as random access memory (168) (‘RAM’) which is connected through a high-speed memory bus (166) and bus adapter (158) to processor (156) and to other components of the triple server. The processor is connected through a video bus (164) to a video adapter (209) and a computer display (180). The processor is connected through an expansion bus (160) to a communications adapter (167), an I/O adapter (178), and a disk drive adapter (172). The processor is connected to a speech-enabled laptop (126) through data communications network (100) and wireless connection (118). Disposed in RAM is an operating system (154).

Also disposed in RAM are a triple server application program (297), a semantic query engine (298), a semantic triple store (814), a triple parser/serializer module (294), a triple converter module (292), and one or more triple files (290). The triple server application program (297) accepts, through network (100) from speech-enabled devices such as laptop (126), semantic queries that it passes to the semantic query engine (298) for execution against the triple stores (323, 325).

The triple parser/serializer module (294) administers the transfer of triples between triple stores and various forms of disk storage. The triple parser/serializer (294) accepts as inputs the contents of triple stores and serializes them for output as triple files (290), tables, relational database records, spreadsheets, or the like, for long-term storage in non-volatile memory, such as, for example, a hard disk (170). The triple parser/serializer (294) accepts triple files (290) as inputs and outputs parsed triples into triple stores. In many embodiments, when the triple parser/serializer (294) accepts triple files (290) as inputs and outputs parsed triples into triple stores.

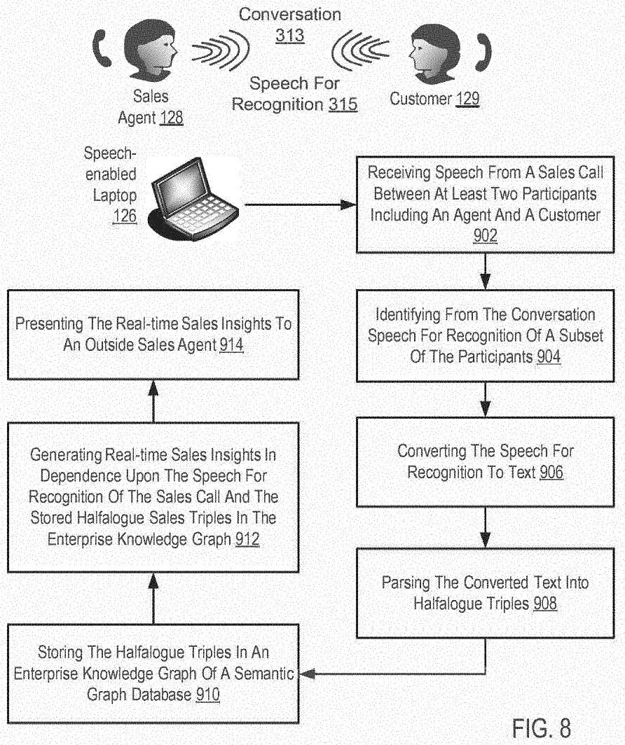

For further explanation, FIG. 8 sets forth a flow chart illustrating an example method for halfalogue insight generation according to embodiments of the present technology. The method of FIG. 8 includes receiving (902) speech from a sales call between at least two participants (128, 129) including an agent (128) and a customer (129). Receiving (902) speech from a sales call between at least two participants (128, 129) including an agent (128) and a customer (129) may be carried out through a speech enabled device. In some embodiments, the conversation including speech from all participants is initially received an only a subset of that speech is used for insight generation according to embodiments of the present technology.

The method of FIG. 8 includes identifying (904) from the conversation speech for recognition (315) of a subset (128) of the participants (128, 129). Identifying (904) from the conversation speech for recognition (315) of a subset (128) of the participants (128, 129) may be carried out by comparing speech received from all the participants of a conversation with voiceprints of participants who have previously authorized the recording and use of their speech. Such a voiceprint may be compared with speech at each interval where speech is initiated, at each word, at the beginning of a conversation or in other ways and at other time intervals.

The method of FIG. 8 includes converting (906) the speech for recognition (315) to text. Converting (906) the speech for recognition (315) to text may be carried out using a grammar module, a lexicon module, and/or an acoustic model of a speech engine as discussed above.

The method of FIG. 8 includes parsing (908) the converted text into halfalogue triples. Parsing (908) the converted text into halfalogue triples may be carried out by a triple parser/serializer module based in part on a taxonomy adapted for halfalogue insight generation according to embodiments of the present technology.

The method of FIG. 8 includes storing (910) the halfalogue triples in an enterprise knowledge graph of a semantic graph database. Storing (910) the halfalogue triples in an enterprise knowledge graph of a semantic graph database may be carried out by invoking a DBMS of a sematic graph database administering the enterprise knowledge graph.

The method of FIG. 8 includes generating (912) real-time sales insights based in part on the speech for recognition of the sales call and the stored halfalogue sales triples in the enterprise knowledge graph. Generating (912) real-time sales insights in dependence upon the speech for recognition of the sales call and the stored halfalogue sales triples in the enterprise knowledge graph may be carried out by querying, e.g., by an intelligence assistant, an enterprise knowledge graph populated with triples according to embodiments of the present technology. In some embodiments of the present technology, a halfalogue insight generator administered by an intelligence assistant selects or generates queries and invokes a query engine of a semantic graph database housing the enterprise knowledge graph.

The method of FIG. 8 includes presenting (914) the real-time sales insights to one or more sales agent. Presenting (914) the real-time sales insights to one or more sales agents may be carried out by displaying insights and delivery notes on a dashboard available to an inside sales agent. Alternatively, such insights may be presented to an agent by automated speech, email, instant message, tabular display and reports, etc. Such sales insights may also be presented to outside sales agents on a mobile device, through automated speech, messaging or in other ways.

It will be understood from the foregoing description that modifications and changes may be made in various embodiments of the present technology without departing from its true spirit. The descriptions in this specification are for purposes of illustration only and are not to be construed in a limiting sense.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively, or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random-access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid-state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML, page, to a user device, e.g., for purposes of displaying data to and receiving user input from a user interacting with the device, which acts as a client. Data generated at the user device, e.g., a result of the user interaction, can be received at the server from the device.

What is claimed is:

1. A method for halfalogue insight generation, the method comprising:
receiving speech from a sales call between at least two participants including an agent and a customer;
identifying from the conversation, speech contributions from a subset of the participants;
converting the speech contributions to text;
parsing the converted text into halfalogue triples;
storing the halfalogue triples in an enterprise knowledge graph of a semantic graph database;
generating real-time sales insights from the stored halfalogue triples in the enterprise knowledge graph; and
presenting the real-time sales insights to one or more sales agents or management.

2. The method of claim 1, wherein identifying the speech contributions includes comparing a voice print of at least one participant within the speech contributions.

3. The method of claim 1, wherein identifying the speech contributions includes identifying speech contributions from all participants of the sales call and recording speech contribution of only the subset of the participants.

4. The method of claim 1, wherein identifying the speech contributions includes identifying speech contribution of the sales agent and recording the speech contribution of the sales agent.

5. The method of claim 1, wherein converting the speech contributions to text comprises invoking an automated speech recognition engine to convert the speech contributions into text using a grammar module, a lexicon module, and an acoustic model.

6. The method of claim 1, wherein parsing the converted text into halfalogue triples includes applying a halfalogue taxonomy.

7. The method of claim 1, wherein generating real-time sales insights based on the stored halfalogue triples in the enterprise knowledge graph includes querying an enterprise knowledge graph storing the halfalogue triples and identifying one or more insights in dependence upon query results.

8. The method of claim 1, wherein the real-time sales insights include budget, authority, need, and time insights.

9. The method of claim 1, further comprising, determining, from the halfalogue triples, an industry for the speech contributions, wherein the real-time sales insights are selected based in part on the industry.

10. A system for halfalogue insight generation, the system comprising automated computing machinery stored on computer-readable non-transitory medium configured for:
receiving speech from a sales call between at least two participants including an agent and a customer;
identifying from the conversation, speech contributions from a subset of the participants;
converting the speech contributions to text;
parsing the converted text into halfalogue triples;
storing the halfalogue triples in an enterprise knowledge graph of a semantic graph database;
generating real-time sales insights from the stored halfalogue triples in the enterprise knowledge graph; and
presenting the real-time sales insights to one or more sales agents or management.

11. The system of claim 10, further configured for comparing a voice print of at least one participant within the speech contributions.

12. The system of claim 10, further configured for identifying speech contributions from all participants of the sales call and recording the speech contributions of only the subset of the participants.

13. The system of claim 10, further configured for identifying speech contributions from the sales agent and recording the speech of the sales agent.

14. The system of claim 10, further configured for invoking an automated speech recognition engine to convert the speech contributions for recognition into text in dependence upon a grammar module, a lexicon module, and an acoustic model.

15. The system of claim 10, further configured for applying a halfalogue taxonomy.

16. The system of claim 10, further configured for querying an enterprise knowledge graph storing the halfalogue triples and identifying one or more insights in dependence upon query results.

17. The system of claim 10, wherein the real-time sales insights include budget, authority, need, and time insights.

18. The system of claim 10, further configured to determine, from the halfalogue triples, an industry for the speech contributions, wherein the real-time sales insights are selected based in part on the industry.

19. One or more non-transitory computer storage media encoded with computer program instructions for halfalogue insight generation that when executed by one or more computers cause the one or more computers to perform operations comprising:
receiving speech from a sales call between at least two participants including an agent and a customer;
identifying from the conversation, speech contributions from a subset of the participants;
converting the speech contributions to text;
parsing the converted text into halfalogue triples;
storing the halfalogue triples in an enterprise knowledge graph of a semantic graph database;
generating real-time sales insights from the stored halfalogue triples in the enterprise knowledge graph; and
presenting the real-time sales insights to one or more sales agents or management.
